(19) United States
(12) Patent Application Publication
(10) Pub. No.: US 2011/0106505 A1
(43) Pub. Date: May 5, 2011

(54) METHOD FOR ESTIMATING AMBIENT AIR TEMPERATURE PRIOR TO COMBUSTION IN AN INTERNAL COMBUSTION ENGINE

(75) Inventors: Jeffery S. Hawkins, Farmington Hills, MI (US); Mark A. Zurawski, Northville, MI (US)

(73) Assignee: Detroit Diesel Corporation, Detroit, MI (US)

(21) Appl. No.: 12/610,697

(22) Filed: Nov. 2, 2009

(51) Int. Cl. G06G 7/56; G06F 17/10

(52) U.S. Cl. 703/2; 703/6

(57) ABSTRACT

A method to estimate ambient air temperature in the vicinity of a vehicle equipped with an internal combustion engine equipped with at least an electronic control unit (ECU) with memory and a temperature sensor.

### TECHNICAL FIELD

Ambient air temperature information is useful for a variety of vehicle/equipment applications such as engine control, diagnostics, aftertreatment control, and complying with On Board Diagnostic (OBD) requirements such as monitor performance reporting and tracking. Both OBD systems and SCR heating control systems are examples in which it is necessary to have fairly accurate ambient temperature information. There are already existing temperature sensors located in strategic points of the engine and aftertreatment system such as intake manifold temperature, charge air cooler outlet temperature, DOC inlet temperature, DOC outlet temperature, DPF outlet temperature, SCR inlet temperature and, SCR outlet temperature, In a cost competitive environment, manufacturers are reluctant to install additional sensors, such as ambient temperature sensors, due to additional vehicle costs that would be incurred both from the purchase of additional components and the additional manufacturing cost to install said components. Also, additional components increase potential liability for warranty costs.

There is a need for a method to estimate ambient air temperatures in order to avoid having to install an ambient temperature sensor. In addition, there is a need to avoid some of the issues associated with a physical ambient temperature relative to environmental influences (engine compartment heat, direct sunlight, radiated heat from pavement, etc.,) that may cost higher than actual readings. Furthermore, with the method of ambient temperature estimation described here, there is a need for a method that takes into account any differences between the ambient air temperature an estimated ambient air temperature and provides for an incremental rise of the estimated ambient air temperature if it is lower than the actual ambient air temperature.

### SUMMARY OF THE INVENTION

In one embodiment, the present application relates to a method to estimate ambient air temperature in the vicinity of a vehicle equipped with aninternal combustion engine equipped with at least an electronic control unit (ECU) with memory, and a charge air cooler outlet temperature sensor. The method may include the steps of:

determining whether an ignition off period exceeds a calibratible predetermined period of time;

initializing an ambient air temperature estimate based upon either the last ambient air temperature estimate value stored in memory or from the charge air cooler outlet temperature values immediately after ignition is enabled, depending on the time since the last ignition off event;

determining a minimum charge air cooler outlet value for a predetermined calibratible period of time;

comparing the actual minimum charge air cooler outlet temperature value over a predetermined calibratible period of time to last estimated inlet air ambient temperature;

utilizing the last estimated ambient air temperature as the ambient air temperature estimate if it is lower than the actual ambient air temperature; and

increasing the ambient temperature estimate as a calibratible function of vehicle speed if the minimum charge air cooler outlet temperature value for a calibratible period of time is higher than the actual ambient air temperature

The actual ambient air temperature may be determined based upon intake manifold air temperature, turbo compressor inlet air temperature, or turbo compressor outlet air temperature.

The method may further include using a low pass filter when the actual charge air cooler outlet temperature is lower than the estimated ambient air temperature. In such a case, both temperature values are passed through a low pass filter to determine an incremental rise to a useable ambient air temperature value. The incremental rise in ambient air temperature of a useable ambient air temperature value is determined according to the algorithm:

Y(n)=[1−filter constant]×(n)+filter constant Y(n−1)

The filter constant may be based upon vehicle speed to compensate for heat soaks. Vehicle speed may be determined by measuring wheel speed, road speed or transmission speed.

### BRIEF DESCRIPTION OF THE DRAWINGS

FIG. 1 is a schematic overview of an internal combustion engine system.

FIG. 2 is a schematic representation of one software flow diagram showing one method according to the present application.

### DETAILED DESCRIPTION

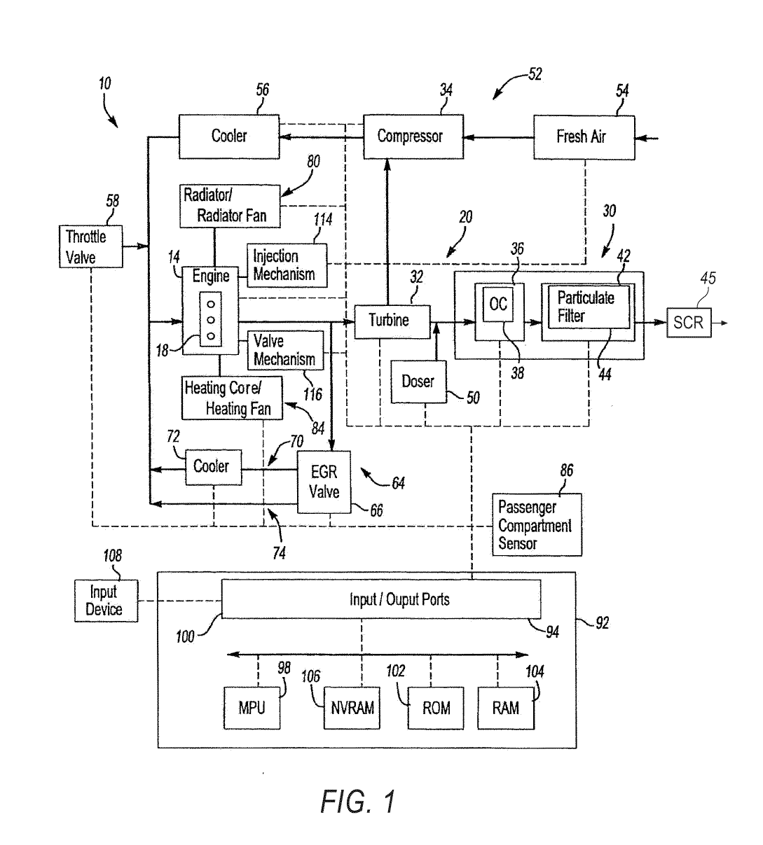

FIG. 1 illustrates a vehicle powertrain system 10 in accordance with one non-limiting aspect of the present invention. The system 10 may provide power for driving any number of vehicles, including on-highway trucks, construction equipment, marine vessels, stationary generators, automobiles, trucks, tractor-trailers, boats, recreational vehicle, light and heavy-duty work vehicles, and the like.

The system 10 may be referred to as an internal combustion driven system wherein fuels, such as gasoline and diesel fuels, are burned in a combustion process to provide power, such as with a compression ignition engine 14. The engine 14 may be a diesel engine that includes a number of cylinders 18 into which fuel and air are injected for ignition as one skilled in the art will appreciate. The engine 14 may be a multi-cylinder compression ignition internal combustion engine, such as a 4, 6, 8, 12, 16, or 24 cylinder diesel engines, for example.

Exhaust gases generated by the engine 14 during combustion may be emitted through an exhaust system 20. The exhaust system 20 may include any number of features, including an exhaust manifold and passageways to deliver the emitted exhaust gases to a particulate filter assembly 30, which in the case of diesel engines is commonly referred to as a diesel particulate filter. Optionally, the system 20 may include a turbocharger proximate the exhaust manifold for compressing fresh air delivery into the engine 14. The turbocharger, for example, may include a turbine 32 and a compressor 34, such as a variable geometry turbocharger (VGT) and/or a turbo compound power turbine. Of course, the present invention is not limited to exhaust systems having turbochargers or the like.

The particulate filter assembly 30 may be configured to capture particulates associated with the combustion process. In more detail, the particulate filter assembly 30 may include an oxidation catalyst (OC) canister 36, which in includes an OC 38, and a particulate filter canister 42, which includes a particulate filter 44. The canisters 36, 42 may be separate components joined together with a clamp or other feature such that the canisters 36, 42 may be separated for servicing and other operations. Of course, the present invention is not intended to be limited to this exemplary configuration for the particulate filter assembly 30. Rather, the present invention contemplates the particulate filter assembly including more or less of these components and features. In particular, the present invention contemplates the particulate filter assembly 30 including only the particulate filter 44 and not necessarily the OC canister 36 or substrate 38 and that the particulate filter 44 may be located in other portions of the exhaust system 20, such as upstream of the turbine 32.

The OC 38, which for diesel engines is commonly referred to as a diesel oxidation catalyst, may oxidize hydrocarbons and carbon monoxide included within the exhaust gases so as to increase temperatures at the particulate filter 44. The particulate filter 44 may capture particulates included within the exhaust gases, such as carbon, oil particles, ash, and the like, and regenerate the captured particulates if temperatures associated therewith are sufficiently high. In accordance with one non-limiting aspect of the present invention, one object of the particulate filter assembly 30 is to capture harmful carbonaceous particles included in the exhaust gases and to store these contaminates until temperatures at the particulate filter 44 favor oxidation of the captured particulates into a gas that can be discharged to the atmosphere.

The OC and particulate filter canisters 36, 42 may include inlets and outlets having defined cross-sectional areas with expansive portions therebetween to store the OC 38 and particulate filter 44, respectively. However, the present invention contemplates that the canisters 36, 42 and devices therein may include any number configurations and arrangements for oxidizing emissions and capturing particulates. As such, the present invention is not intended to be limited to any particular configuration for the particulate filter assembly 30.

To facilitate oxidizing the capture particulates, a doser 50 may be included to introduce fuel to the exhaust gases such that the fuel reacts with the OC 38 and combusts to increase temperatures at the particulate filter 44, such as to facilitate regeneration. For example, one non-limiting aspect of the present invention contemplates controlling the amount of fuel injected from the doser as a function of temperatures at the particulate filter 44 and other system parameters, such as air mass flow, EGR temperatures, and the like, so as to control regeneration. However, the present invention also contemplates that fuel may be included within the exhaust gases through other measures, such as by controlling the engine 14 to emit fuel with the exhaust gases.

An air intake system 52 may be included for delivering fresh air from a fresh air inlet 54 through an air passage to an intake manifold for introduction to the engine 14. In addition, the system 52 may include an air cooler or charge air cooler 56 to cool the fresh air after it is compressed by the compressor 34. Optionally, a throttle intake valve 58 may be provided to control the flow of fresh air to the engine 14. The throttle valve 58 may be an electrically operated valve. There are many variations possible for such an air intake system and the present invention is not intended to be limited to any particular arrangement. Rather, the present invention contemplates any number of features and devices for providing fresh air to the intake manifold and cylinders, including more or less of the foregoing features.

An exhaust gas recirculation (EGR) system 64 may be optionally provided to recycle exhaust gas to the engine 14 for mixture with the fresh air. The EGR system 64 may selectively introduce a metered portion of the exhaust gasses into the engine 14. The EGR system 64, for example, may dilute the incoming fuel charge and lower peak combustion temperatures to reduce the amount of oxides of nitrogen produced during combustion. The amount of exhaust gas to be re-circulated may be controlled by controlling an EGR valve 66 and/or in combination with other features, such as the turbocharger. The EGR valve 66 may be a variable flow valve that is electronically controlled. There are many possible configurations for the controllable EGR valve 66 and embodiments of the present invention are not limited to any particular structure for the EGR valve 66.

The EGR system 64 in one non-limiting aspect of the present invention may include an EGR cooler passage 70, which includes an air cooler 72, and an EGR non-cooler bypass 74. The EGR value 66 may be provided at the exhaust manifold to meter exhaust gas through one or both of the EGR cooler passage 70 and bypass 74. Of course, the present invention contemplates that the EGR system 64 may include more or less of these features and other features for recycling exhaust gas. Accordingly, the present invention is not intended to be limited to any one EGR system and contemplates the use of other such systems, including more or less of these features, such as an EGR system having only one of the EGR cooler passage or bypass.

A cooling system 80 may be included for cycling the engine 14 by cycling coolant therethrough. The coolant may be sufficient for fluidly conducting away heat generated by the engine 14, such as through a radiator. The radiator may include a number of fins through which the coolant flows to be cooled by air flow through an engine housing and/or generated by a radiator fan directed thereto as one skilled in the art will appreciated. It is contemplated, however, that the present invention may include more or less of these features in the cooling system 80 and the present invention is not intended to be limited to the exemplary cooling system described above.

The cooling system 80 invention may operate in conjunction with a heating system 84. The heating system 84 may include a heating cone, a heating fan, and a heater valve. The heating cone may receive heated coolant fluid from the engine 14 through the heater valve so that the heating fan, which may be electrically controllable by occupants in a passenger area or cab of a vehicle, may blow air warmed by the heating cone to the passengers. For example, the heating fan may be controllable at various speeds to control an amount of warmed air blown past the heating cone whereby the warmed air may then be distributed through a venting system to the occupants. Optionally, sensors and switches 86 may be included in the passenger area to control the heating demands of the occupants. The switches and sensors may include dial or digital switches for requesting heating and sensors for determining whether the requested heating demand was met. The present invention contemplates that more or less of these features may be included in the heating system and is not intended to be limited to the exemplary heating system described above.

A controller 92, such as an electronic control module or engine control module, may be included in the system 10 to control various operations of the engine 14 and other system or subsystems associated therewith, such as the sensors in the exhaust, EGR, and intake systems. Various sensors may be in electrical communication with the controller via input/output ports 94. The controller 92 may include a microprocessor unit (MPU) 98 in communication with various computer readable storage media via a data and control bus 100. The computer readable storage media may include any of a number of known devices which function as read only memory 102, random access memory 104, and non-volatile random access memory 106. A data, diagnostics, and programming input and output device 108 may also be selectively connected to the controller via a plug to exchange various information therebetween. The device 108 may be used to change values within the computer readable storage media, such as configuration settings, calibration variables, instructions for EGR, intake, and exhaust systems control and others.

The system 10 may include an injection mechanism 114 for controlling fuel and/or air injection for the cylinders 18. The injection mechanism 114 may be controlled by the controller 92 or other controller and comprise any number of features, including features for injecting fuel and/or air into a common-rail cylinder intake and a unit that injects fuel and/or air into each cylinder individually. For example, the injection mechanism 114 may separately and independently control the fuel and/or air injected into each cylinder such that each cylinder may be separately and independently controlled to receive varying amounts of fuel and/or air or no fuel and/or air at all. Of course, the present invention contemplates that the injection mechanism 114 may include more or less of these features and is not intended to be limited to the features described above.

The system 10 may include a valve mechanism 116 for controlling valve timing of the cylinders 18, such as to control air flow into and exhaust flow out of the cylinders 18. The valve mechanism 116 may be controlled by the controller 92 or other controller and comprise any number of features, including features for selectively and independently opening and closing cylinder intake and/or exhaust valves. For example, the valve mechanism 116 may independently control the exhaust valve timing of each cylinder such that the exhaust and/or intake valves may be independently opened and closed at controllable intervals, such as with a compression brake. Of course, the present invention contemplates that the valve mechanism may include more or less of these features and is not intended to be limited to any of the features described above.

In operation, the controller 92 receives signals from various engine/vehicle sensors and executes control logic embedded in hardware and/or software to control the system 10. The computer readable storage media may, for example, include instructions stored thereon that are executable by the controller 92 to perform methods of controlling all features and sub-systems in the system 10. The program instructions may be executed by the controller in the MPU 98 to control the various systems and subsystems of the engine and/or vehicle through the input/output ports 94. In general, the dashed lines shown in FIG. 1 illustrate the optional sensing and control communication between the controller and the various components in the powertrain system. Furthermore, it is appreciated that any number of sensors and features may be associated with each feature in the system for monitoring and controlling the operation thereof.

In one non-limiting aspect of the present invention, the controller 92 may be the DDEC controller available from Detroit Diesel Corporation, Detroit, Mich. Various other features of this controller are described in detail in a number of U.S. patents assigned to Detroit Diesel Corporation. Further, the controller may include any of a number of programming and processing techniques or strategies to control any feature in the system 10. Moreover, the present invention contemplates that the system may include more than one controller, such as separate controllers for controlling system or sub-systems, including an exhaust system controller to control exhaust gas temperatures, mass flow rates, and other features associated therewith. In addition, these controllers may include other controllers besides the DDEC controller described above.

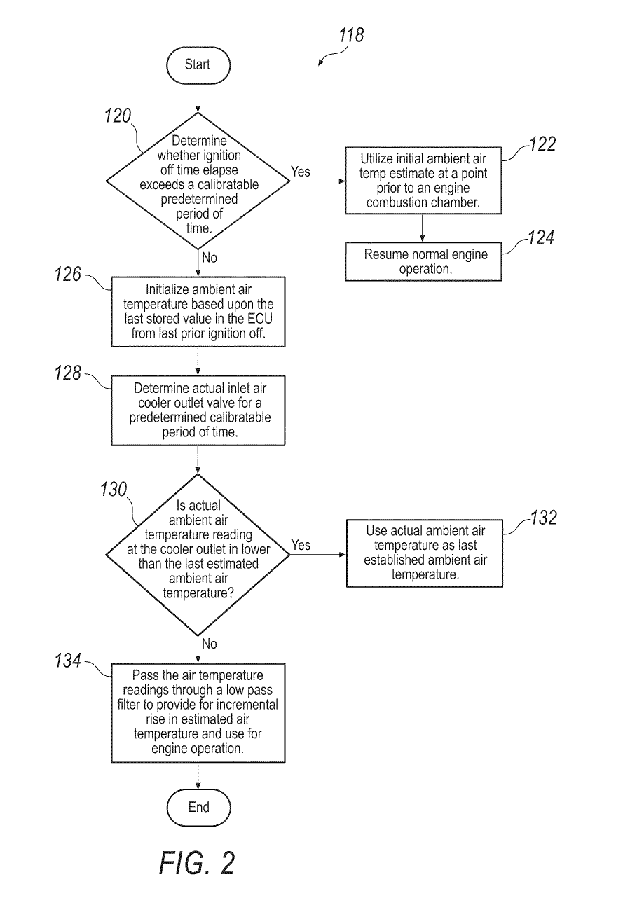

FIG. 2 is a software flowchart showing one method 118 according to one embodiment of the present application. Specifically step 120 is determining whether the ignition off time elapse has exceeded a calibratible predetermined period of time. If yes, the software follows step 122, and the ECU utilizes an initial ambient air temperature estimate at a point prior to a combustion chamber of the engine. This point may be at the turbo charger cooler outlet, the air manifold outlet, or any other air outlet of the engine. The engine then follows step 124, and normal engine operation continues.

If the determination in step 120 is that the ignition off time does not exceed a predetermined calibratible period of time, step 126 is to initialize the ambient air temperature based on the last stored value in the ECU from the last prior ignition off event.

Step 128 is to determine the actual inlet air cooler outlet value for a predetermined calibratible period of time. Generally about one (1) minute is sufficient, but it is understood that any time period can be used, depending upon operating conditions. Step 130 is determining whether any actual ambient air temperature reading at the cooler outlet is lower than the last estimated ambient air temperature. If yes, step 132 is use the lower actual ambient air temperature as the last estimated ambient air temperature. If it is determined that the actual ambient air temperature is greater than the estimated ambient air temperature, the data is passes through a low pass filter or alternative mehod by which to provide for an incremental rise in the estimated ambient air temperature used by the vehicle engine for operation at step 134. The incremental rise may be determined by the algorithm:

Y(n)=[1−filter constant]×(n)+filter constant Y(n−1)

wherein the filter constant may be based upon vehicle speed to compensate for heat soaks, and heat soaks may be determined by measuring vehicle speed, by reference to wheel speed, road speed or transmission speed, or any other method to measure vehicle speed.

The words used in this application are words of description, and not words of limitation. Many variations and modifications will become apparent to those skilled in the art without departing form the scope and spirit of the invention as set forth in the appended claims.

We claim:

1. A method to estimate ambient air temperature for the ambient air within the vicinity of any vehicle/equipment equipped with an engine having at least an electronic control unit (ECU) with memory and a charge air cooler outlet temperature measurement, comprising:
determining whether an ignition off period exceeds a calibratible predetermined period of time;
initializing an ambient air temperature estimate based upon a last ambient air temperature value stored in memory from a last ignition off event;
determining a charge air cooler cooler outlet value for a predetermined calibratible period of time;
comparing an actual inlet air low temperature to last estimated inlet air ambient temperature over a predetermined calibratible period of time;
utilizing a last estimated ambient air temperature as the ambient air temperature estimate if it is lower than the actual ambient air temperature; and
increasing the ambient temperature estimate as a calibratible function of vehicle speed if the minimum charge air cooler outlet temperature value for a calibratible period of time is higher than the actual ambient air temperature.

2. The method of claim 1, wherein if the actual ambient air temperature is lower than the estimated ambient air temperature, both temperature values are passed through a low pass filter to determine an incremental rise to a useable ambient air temperature value.

3. The method of claim 1, wherein said actual ambient air temperature may be measured based upon intake manifold temperature, turbo compressor inlet temperature, or turbo compressor outlet temperature.

4. The method of claim 2, wherein said incremental rise in ambient air temperature of a useable ambient air temperature value is determined according to
Y(n)=[1−filter constant]×(n)+filter constant Y(n−1)

5. The method of claim 4, wherein said filter constant may be based upon vehicle speed to compensate for heat soaks.

6. The method of claim 5, wherein said vehicle speed is determined by measuring at least one of wheel speed, road speed, and transmission speed.
